(19) United States
(12) Patent Application Publication
(10) Pub. No.: US 2025/0345228 A1
(43) Pub. Date: Nov. 13, 2025

(54) SPINAL SUPPORT DEVICES AND METHODS OF USE

(71) Applicant: CONTOUREAL LLC, Portland, OR (US)

(72) Inventor: Parviz JAHANGIRI, Portland, OR (US)

(21) Appl. No.: 18/658,456

(22) Filed: May 8, 2024

(51) Int. Cl. A61H 1/02

(52) U.S. Cl. CPC A61H 1/0296; A61H 2201/0192; A61H 2201/1609; A61H 2201/1623; A61H 2201/1628; A61H 2201/1645; A61H 2203/0456

(57) ABSTRACT

Illustrative spinal support devices have a base unit, a neck support unit defining a first end, an upper thigh support unit defining a second end, and a mid-back support unit positioned between the neck and upper thigh support units, wherein the neck, upper thigh, and mid-back support units each have a convex shaped topside with an apex that is configured to align within designated concave shaped areas on the user's backside. Illustrative related methods are described.

### RELATED APPLICATIONS

The following applications and materials are incorporated herein by reference, in their entireties, for all purposes: U.S. patent application Ser. No. 18/097,132, filed Jan. 13, 2023, now U.S. Pat. No. 11,752,057.

### BACKGROUND

Spinal pain and abnormal curvature are common and difficult problems for many people. These often result from significant and/or prolonged stress from the body simply supporting itself under normal conditions, physical exercise, or improper posture while sitting or standing.

Accordingly, there is a need in the art for a portable spinal support device designed for a particular user's anatomy and spinal issues that can help prevent or treat spinal malformities to maintain or restore normal spinal curvature. People having significantly different anatomies or spinal misalignments should have access to different spinal support devices configured or otherwise customized to be used with their specific characteristics. It may be desirable for spinal support devices to have the ability to both provide axial compressive load to the vertebrae to stimulate bone growth and induce corrective spinal curvature from the lordotic neck curvature to the sacral curvature while the user is in a supine position.

### SUMMARY

In some examples, a spinal support device may comprise a base unit having a longitudinal axis along first and second ends, and having a neck support unit defining the first end, an upper thigh support unit defining the second end, and a mid-back support unit positioned between said neck and upper thigh support units.

### BRIEF DESCRIPTION OF DRAWINGS

FIG. 1 is an exploded, perspective view of a spinal support device.

FIG. 2 is an assembled perspective view of a spinal support device.

FIG. 3 is an exploded, topside view of a spinal support device.

FIG. 4 is an assembled, topside view of a spinal support device.

FIG. 5 is an exploded, left-side view of a spinal support device.

FIG. 6 is an assembled, left-side view of a spinal support device.

FIG. 7 is an assembled, left-side view of a spinal support device with a user in a supine position.

FIG. 8 is a drawing of a spine showing transitional points of curvature.

FIG. 9 is an assembled side view of a spinal support device annotated with example dimensions.

FIG. 10 is an exploded topside view of a spinal support device annotated with example dimensions.

### DETAILED DESCRIPTION

In some examples in accordance with aspects of the present teachings, methods of using a spinal support device on a human may comprise: providing a spinal support device comprising a base unit having a longitudinal axis along first and second ends, and having a neck support unit defining the first end, a upper thigh support unit defining the second end, and a mid-back support unit positioned between said neck and upper thigh support units, wherein the neck, upper thigh, and mid-back support units each have a convex shaped topside with an apex; and positioning the person on the device in a supine position, wherein, the apex of the mid-back support unit supports the center, or within 0.5 inches up or down from said center, of the L1 vertebra, the apex of the neck support unit supports the center, or within 0.5 inches up or down from said center, of the C5 vertebra, and the apex of the upper thigh support unit supports the upper thighs.

In some examples, the neck support unit is configured to be slidable and releasably lockable along the longitudinal axis of the base unit both towards and away from the mid-back support unit so as to form a first gap between the neck support unit and the mid-back support unit; and the upper thigh support unit is configured to be slidable and releasably lockable along the longitudinal axis of the base unit both towards and away from the mid-back support unit so as to form a second gap between the upper thigh support unit and the mid-back support unit.

Some example methods further comprise measuring the length of a predetermined span of the human's spine and adjusting the neck and upper thigh support units either closer to or away from the mid-back support unit based on the measured length, wherein, for a first person having a longer measurement than a second person, the neck and upper thigh support units are moved away from the mid-back support unit for the first person and moved closer to the mid-back support unit for the second person.

In some examples, when the upper thigh support and the neck supports are moved away from the mid-back support and releasably locked, the second gap between the upper thigh support unit and the mid-back support unit is longer in length than the first gap between the neck support unit and the mid-back support unit.

In some examples, the length of the second gap is between 1.025 to 1.225 times greater than the length of the first gap.

In some examples, the length of the second gap is 1.125 times greater than the length of the first gap.

In some examples, intermittent locking points are set between: a) the neck support unit and mid-back support unit, and b) the upper thigh support unit and the mid-back support unit, such that the neck and upper thigh support units are releasably lockable at these points along the longitudinal axis and correspond to preset measured lengths of the predetermined span of the human's spine.

In some examples, the predetermined span of the human's spine that is measured is the distance between the top of the T1 vertebra to the bottom of the sacrum.

In some examples, the predetermined span is measured by having the user sit upright on a surface and measuring the distance between the T1 vertebra and the surface.

In some examples, when the predetermined length of the human spine is 23″ or less, the neck and upper thigh support units are adjacent to the mid-back support such that no first or second gaps exists.

In some examples, when the length of the human spine is between 23″ to 25″, the first gap is between 0 to 1 inches and the second gap is between 1.025 to 1.225 times greater than the length of the first gap.

In some examples, when the length of the human spine is between 25″ to 27″, the first gap is between 1 to 2 inches and the second gap is between 1.025 to 1.225 times greater than the length of the first gap.

In some examples, when the length of the human spine is between 27″ to 29″, the first gap is between 2 to 3 inches and the second gap is between 1.025 to 1.225 times greater than the length of the first gap.

In some examples, when the length of the human spine is between 29″ to 31″, the first gap is between 3 to 4 inches and the second gap is between 1.025 to 1.225 times greater than the length of the first gap.

In some examples, when the length of the human spine is between 31″ to 33″, the first gap is between 4 to 5 inches and the second gap is between 1.025 to 1.225 times greater than the length of the first gap.

In some examples, the neck, upper thigh, and mid-back support units are not slidable along the longitudinal axis on the base, such that they are fixed in place.

Some example methods further comprise measuring the length of a predetermined span of the human's spine and selecting the spinal support device from first and second spinal support devices, each having differently sized fixed distances between the mid-back support unit and the neck and upper thigh support unit, based on said measurement.

In some examples, the convex shaped topside of at least one of the support units comprises two parallel convex shaped topsides separated by a groove having a width.

In some examples, the two parallel convex shaped topsides can be moved closer to each other and farther away from each other thereby decreasing and enlarging the groove width respectively.

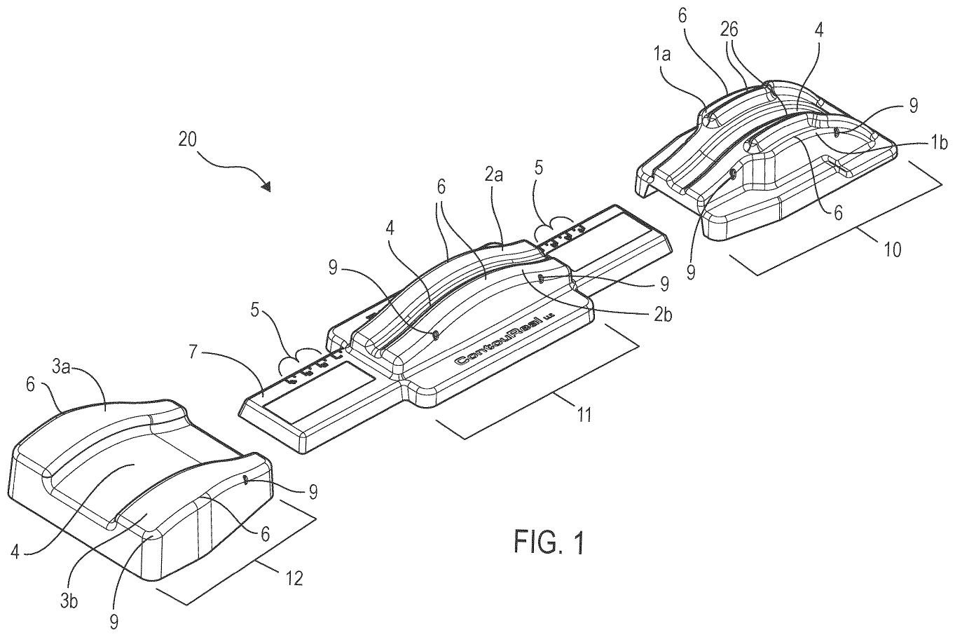

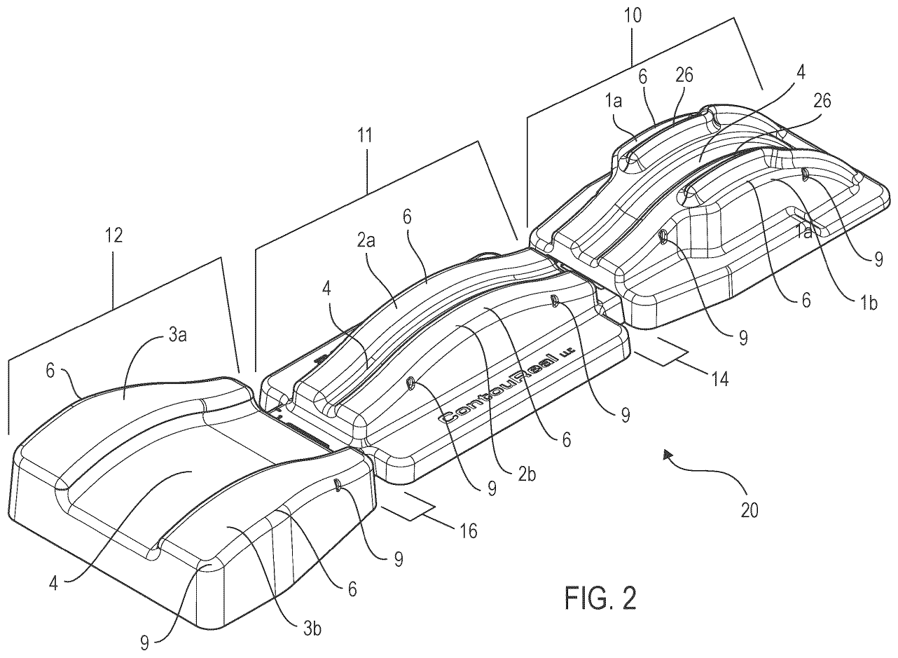

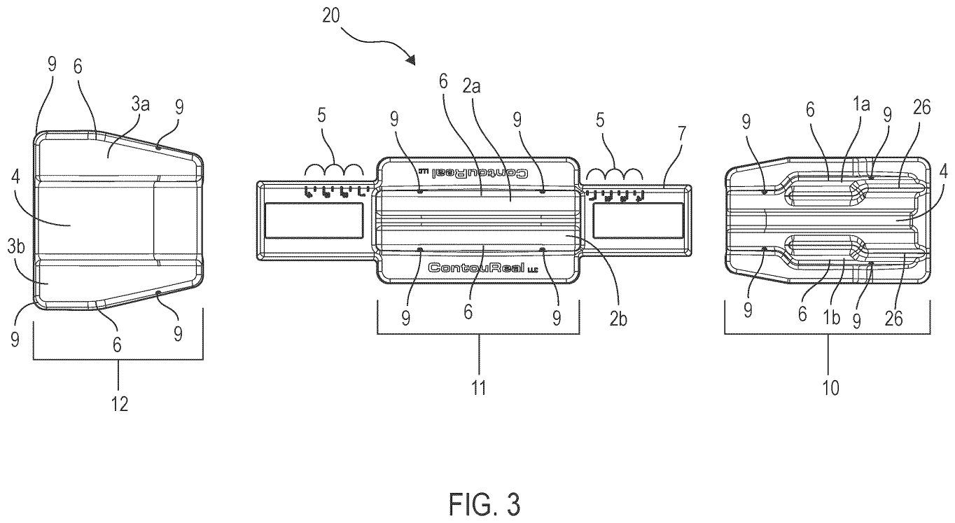

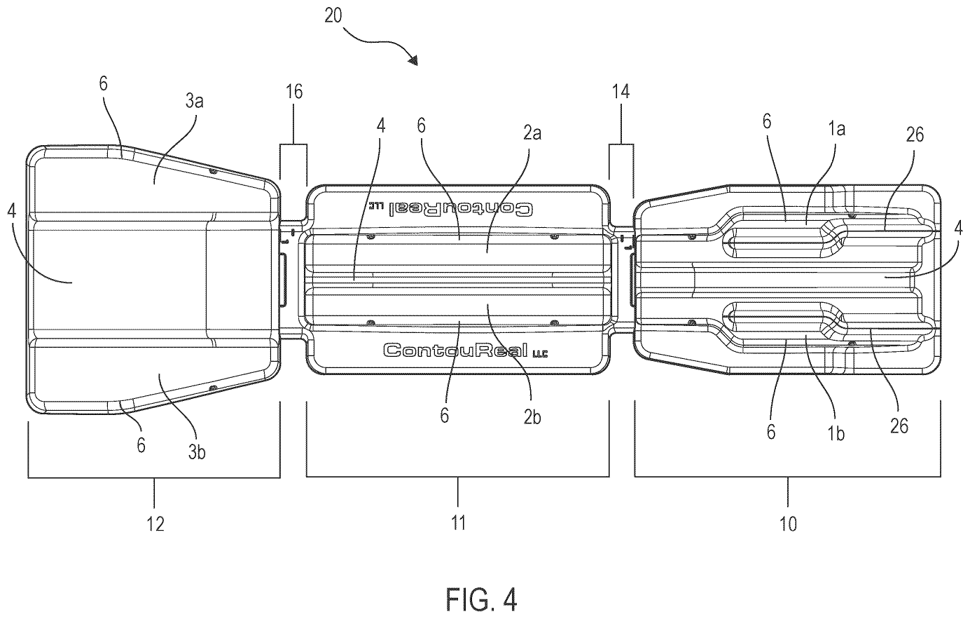

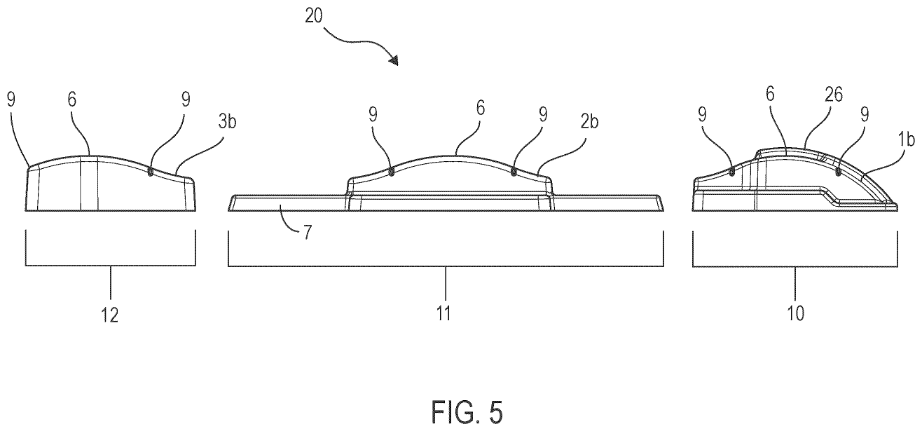

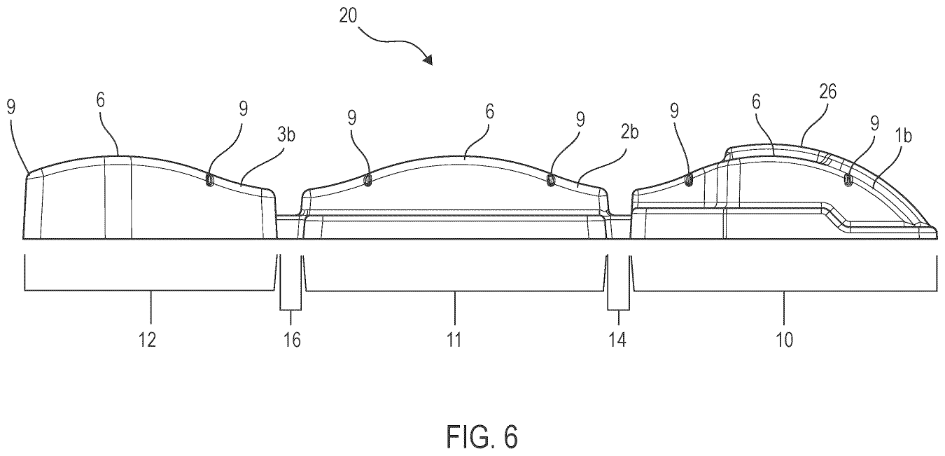

As shown in FIGS. 1-7, illustrative spinal support devices 20 suitable for methods of use described herein comprise a base unit 7 having a longitudinal axis along first and second ends, and three support units: a neck support unit (NSU) 10, a mid-back support unit (MBSU) 11 and an upper thigh support unit (UTSU) 12. Preferably the NSU 10 is positioned at the first end of the base 7, the UTSU 12 is positioned at the second, opposite end of the base 7, and the MBSU 11 is positioned between the NSU 10 and the UTSU 12, in the center of the base 7. While shown in FIGS. 2, 4, and 6 as terminating within the NSU 10 and the UTSU 12, according to some embodiments, the base 7 can extend past NSU 10 and UTSU 12. Regardless of its termination points, in some examples the UTSU 12 and the NSU 10 are the last support units on the base 7, such that there are no further support units positioned past them towards the first and second ends of the base 7 on the longitudinal axis. In some examples, there are only three support units (10, 11, 12) total on the base 7.

In some examples, the base 7 is made of sturdy rigid, or semi-rigid material such as metal (e.g., steel, aluminum or alloy), hard plastic, polyurethane, or carbon, such that it can support the user, and act as a track for embodiments covering sliding NSU 10 and UTSU 12. The underside of the base 7 is in some examples planar, but can also have support legs and/or caster wheels. In some examples, the legs can be adjustable to create customized heights of the device 20. According to further examples, the base 7 can be configured to lengthen or widen, such as through the utilization of a telescoping mechanism and/or extensions.

In some examples, each of the support units (10, 11, 12) has a convex shaped topside with an apex 6. While the convex shaped topside can be a singular feature without a groove (not shown), in some examples each support unit (10, 11, 12) comprises two parallel convex shaped topsides separated by a groove 4 having a width and depth. For example, the NSU 10 and the MBSU 11 can have right and left convex shape topsides 1a/1b and 2a/2b respectively separated by groove 4 that is configured to accommodate the width and depth of a user's spine.

As different users have different spinal configurations and/or malformities, in some examples the right and left convex shape topsides 1a/1b and 2a/2b are configured be adjusted to either expand or decrease the width of the groove 4 to accommodate these differences. The depth of the groove 4 can also be adjustable if desired. The width of the groove can be increased and decreased utilizing any suitable mechanism, such as by decreasing and increasing the width of the right and left convex shape topsides 1a/1b and 2a/2b, respectively. Additionally, a telescoping mechanism, sliding track, and/or extensions can be used. Similarly, the height of the groove can be increased and decreased utilizing any suitable mechanism, such as by increasing and decreasing or the height of the right and left convex shape topsides 1a/1b and 2a/2b, respectively. Additionally, a telescoping mechanism, sliding track, and/or extensions can be used.

The right and left convex shape topsides 1a/1b and 2a/2b can be permanently fixed to the NSU 10 and the MBSU 11 respectively or can be detachable. According to certain examples, a plurality of different sized right and left convex shape topsides 1a/1b and 2a/2b can be provided and selected based on a particular patient's anatomy. Additionally, the right and left convex shape topsides 1a/1b and 2a/2b can be modular wherein layers can be added or removed to achieve different heights and widths, thereby defining different heights and widths of the groove 4. In some examples, the NSU 10 can include two parallel lateral supports 26 to prevent unwanted lateral motion of a user's neck. In some examples, the lateral supports 26 are positioned to be on the outside of the user, such that they sandwich the neck when the user is lying on top of the device 20. Thus, while the lateral supports 26 may have a higher top than the convex shape topsides 1a/1b, the designated apex 6 of the NSU 10 is positioned on the convex shape topsides 1a/1b as shown in FIGS. 1-7. For certain examples the apex 6 is the highest point on the support unit (10, 11, 12).

Additionally, the UTSU 12 can have right and left convex shape topsides 3a/3b separated by a groove 4 as well. As the UTSU 12 does not need to accommodate the user's spine, in some examples its groove is wider than the grooves 4 of the NSU 10 and the MBSU 11, such as over twice or over three times as wide.

In some examples, each of the support units (10, 11, 12) is made of a rigid or semi-rigid material suitable for supporting the user in a supine position, such as plastic, wood, composite wood, metal, and foam. Additional flexible material, including foams, rubber, or other cushioning can be used for comfort. The entire support units (10, 11, 12) can be made of multiple materials or a singular material such as polyurethane.

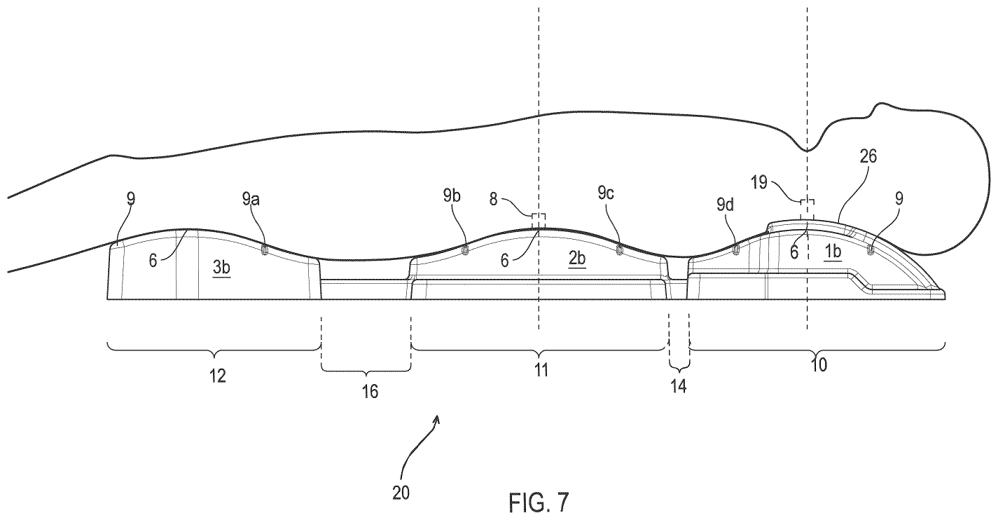

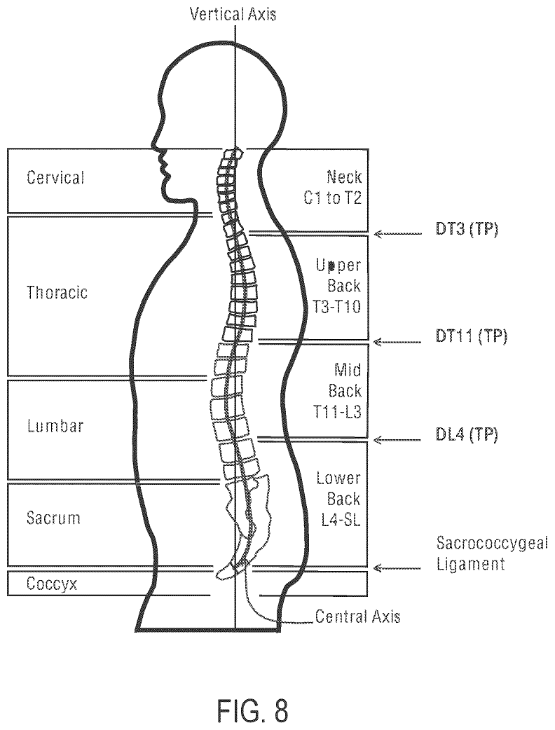

Transition points are points along the spinal column where spinal vertebrae change in lining up from a concave shape to a convex shape. These transition points largely coincide with a vertical line (Vertical Axis) drawn between the top vertebra to the tail bone, and a central line (Central Axis) that connects to the central axis of each vertebra. It is desirable that these transition points be supported or controlled so that they relatively align in a straight line. Transition points also coincide with transverse features on the body such as the nose, the sternomanubrial joint, the xiphisternal joint, the navel, and the hip joints respectively. FIG. 8 shows a human spine with the following transition points: DT3, DT11, DL4 and the sacrococcygeal ligament. In general, and as shown in FIG. 7, normal humans comprise three concave sections on their backside (the neck, mid-back, and the thighs) that the three support units (10, 11, 12) are configured to support and align with their convex shaped topsides 1a/1b, 2a/2b, and 3a/3b. In some examples, devices (e.g., device 20) according to aspects of the present teachings are configured and/or configurable such that the inflection points 9 on the support units (10, 11, 12) vertically align with their respective transition points on the spine, when the user is on the device (e.g., device 20) in a supine position. As used herein the term convex and concave can signify, without limitation, a curved shape, including the arc of a circle, oval, or ellipse; or a shape that is noncurved (e.g., an angular shape); and/or a shape having both curved and noncurved aspects.

In some examples, support units (10, 11, 12) comprise two inflection points 9 that are equidistant from a center apex 6 of the convex shaped topsides 1a/1b, 2a/2b, and 3a/3b. By aligning the center apexes 6 of the support units (10, 11, 12), to their respective center of the spine's concave section being supported, the convex shaped topsides 1a/1b, 2a/2b, and 3a/3b automatically conform to the user's spine. In some examples, each inflection point 9 on each support unit (10, 11, 12), can change distance, symmetrically, based on the user's spinal size and shape, keeping the center apex 6 of each support unit (10, 11, 12) aligned with the user's respective centers of their three concave sections.

As shown in FIG. 7, when a human user is positioned on the device 20 in a supine position, the MBSU 11 generally supports the spine between the T11 and L3 vertebrae, with the apex 6 of the MBSU 11 supporting the center, or within 0.5 inches up or down from said center, of the L1 vertebrae 8. Similarly, the NSU 10 generally supports the spine between the C1 and T2 vertebrae, with the apex 6 of the NSU 10 supporting the center, or within 0.5 inches up or down from said center, of the C5 vertebra 19. Finally, the UTSU 12 generally supports the body between the Sacrococcygeal ligament (SL) and up to the knee joint, with the apex 6 of the UTSU 12 supporting the center, or within 4 inches up or down of said center of the concave section of the back of the thighs, below the glutes. When aligned properly, the SL will align with the inflection point 9 on the UTSU 12 closest to the center. Adjustments can be made for larger spines where the SL sits lower on the inflection point 9 and for smaller spines where the SL sits higher on the inflection point 9.

With continuing reference to FIGS. 7-8, the user's lower back between the L4 vertebra and the SL is disposed over the portion of device 20 extending between inflection point 9a and inflection point 9b; this portion of the device may be referred to as a “lower gravity area.” The user's upper back between the T3 and T10 vertebrae is disposed over the portion of the device extending between inflection point 9c and inflection point 9d; this portion of the device may be referred to as an “upper gravity area.” The curvatures of the MBSU, NSU, and UTSU, together with appropriate spacing of those units in accordance with a user's spinal height, allow the user's lower and upper back to be at least partially suspended at the lower and upper gravity areas respectively (e.g., without “bottoming out” and resting on base 7), which allows the user's back to stretch in a manner that tends to facilitate a healthy spinal curvature, as described elsewhere herein. (Here, the term “inflection point” is used in reference to device 20, whereas the term “transition point” is used in reference to the user's spine.)

The spinal support devices 20 and methods of use described herein can be used to prevent or treat spinal misalignments by maintaining and/or helping restore normal curvature in the spine. According to some examples, the spinal support devices 20 described herein can accommodate different users having different anatomies, non-exclusively including different spinal curvatures, spinal malformities such as kyphosis, lordosis, scoliosis, different lengths of spine, and different transition points within the spine.

Accommodating individualized users having separate anatomies from each other can be accomplished by the following three examples, without limitation.

A first example of accommodating individualized users having different anatomies includes providing a single adjustable device 20 that can be used with each of them. According to this example, the NSU 10 and/or the UTSU 12 are configured to be movable such as to be positioned and releasably locked closer to or further away from the MBSU 11. The MBSU 11 is in some examples fixed in place in the center of the longitudinal axis of the base 7, but can also be configured to be movable and releasably locked along the base 7. As described in more detail below, the NSU 10 and the UTSU 12 are in some examples configured to slide along the longitudinal axis of the base 7 which thus acts as a track. In some examples, the NSU 10 and the UTSU 12 have a recessed section on their underside with lips/tabs to prevent their lateral dislodgement from the base 7. Alternatively, or additionally, the NSU 10 and the UTSU 12 can utilize a hollowed channel within to remain on the base 7 and prevent their lateral dislodgement therefrom. According to some examples (not shown), the NSU 10 and the UTSU 12 can be moved towards and away from the MBSU 11 using a telescoping mechanism and/or extensions.

As shown in FIGS. 1-7, as the NSU 10 moves farther away along the base 7 from the MBSU 11, the gap 14 between the MBSU 11 and the NSU 10 increases in length. Conversely, as the NSU 10 moves closer along the base 7 towards the MBSU 11, the gap 14 between the MBSU 11 and the NSU 10 decreases in length. Similarly, as the UTSU 12 moves farther away along the base 7 from the MBSU 11, the gap 16 between the UTSU 12 and the MBSU 11 increases in length. Conversely, as the UTSU 12 moves closer along the base 7 towards the MBSU 11, the gap 16 between the MBSU 11 and the UTSU 12 decreases in length.

A length D1 may be defined as the distance between the user's C1 and T10 vertebrae, encompassing the neck and upper back. In general (e.g., based on anatomical averages), this length D1 can be divided equally, with around half corresponding to the neck area (C1 to T2) and half to the upper back area (T3 to T10). The distance (½)D1 (that is, D1 divided by 2) may therefore be designated as distance A. In similar fashion, a length D2 may be defined as the distance between the user's T11 vertebra and SL, encompassing the mid and lower back. In general (e.g., based on anatomical averages), this length D2 can be divided equally between the mid back (T11 to L3) and the lower back area (L4 to SL). The distance (½)D2 (that is, D2 divided by 2) may therefore be designated as distance B.

According to this model, and measuring from the C1 vertebra, inflection points (also referred to herein as transition points) on the user's spine are likely to be found naturally at distances A, 2A, 2A+B, and 2A+2B (see FIG. 8). The contours of device 20 provide corresponding inflection points at 9d, 9c, 9b, and 9a. As described in the present disclosure, the distance between inflection points 9d and 9c is adjustable on device 20, as is the distance between inflection points 9b and 9a. These adjustable regions correspond to low points of the overall contours of the support. Although the distance between points 9c and 9b (for example) is fixed, device 20 may be configured such that inflection points on the device correspond sufficiently with any given user's natural spinal inflection points so as to facilitate adjustability without added discomfort.

In some examples, one or more of the NSU, MBSU, or UTSU is configured such that its radius of curvature is adjustable, which may allow the inflection points of device 20 to adjust to the transition points of a particular user's spine.

Some examples involve the use of intermittent locking points 5 that are set on the track 7 between the MBSU 11 and the NSU 10 and also between the MBSU 11 and the UTSU 12, such that the movable UTSU 12 and the NSU 10 are releasably lockable at these points 5 along the longitudinal axis. In some examples, as discussed below, these locking points 5 correspond to preset measured lengths of a predetermined span of the human's spine. Alternatively, and not shown, the movable UTSU 12 and/or the NSU 10 can be releasably locked continuously along the longitudinal axis of the track 7 without designated intermittent locking points. Regardless of whether intermittent or continuous releasable locking is utilized, any feasible releasable locking mechanisms can be used, including tabs, recesses, springs, clamps, and the like. Additional features that could optionally be adjustable non-exclusively include the width or depth of the groove 4 on the support units (10, 11, 12) and the height of the apex 6 of the support units (10, 11, 12), and the distance between inflection points 9 on the convex shape topsides 1a/1b, 2a/2b, and 3a/3b. In some examples, only one support unit selected from the NSU 10 or the UTSU 12 is adjustable along the track 7, and the other is in a fixed position.

A second example of accommodating individualized users includes providing a plurality of different sized, yet adjustable devices 20. According to this example, one or more of the NSU 10 and the UTSU 12 can be slidable along the longitudinal axis on the base 7, such that they are not fixed in place. The plurality of different sized adjustable devices 20 can include a variety of adjustable or non-adjustable differences between them, non-exclusively including overall length of device 20, length of the track 7, the length of the gap (14 and 16) between the MBSU 11 and the NSU 10 and between the MBSU 11 and the UTSU 12, the width or depth of the groove 4 on the support units (10, 11, 12), the height of the apex 6 of the support units (10, 11, 12), and the distance between inflection points 9 on the convex shape topsides 1a/1b, 2a/2b, and 3a/3b. The second example in some cases includes making one or more measurements on the human, non-exclusively including a length of a predetermined span of the human's spine, overall height, and/or curvature types, and selecting a particularly sized spinal support device from the plurality of differently sized yet adjustable spinal support devices, that corresponds to said one or more measurements.

A third example of accommodating individualized users includes providing a plurality of different sized non-adjustable devices 20. According to this example, the support units (10, 11, 12) are not slidable along the longitudinal axis on the base 7, such that they are fixed in place. The plurality of different sized non-adjustable devices 20 can include a variety of differences between them, non-exclusively including overall length of device 20, length of the track 7, the length of the gap (14 and 16) between the MBSU 11 and the NSU 10 and between the MBSU 11 and the UTSU 12, the width or depth of the groove 4 on the support units (10, 11, 12), the height of the apex 6 of the support units (10, 11, 12), and the distance between inflection points 9 on the convex shape topsides 1a/1b, 2a/2b, and 3a/3b. The third example in some cases includes making one or more measurements on the human, non-exclusively including a length of a predetermined span of the human's spine, overall height, and/or curvature, and selecting a particularly sized spinal support device from the plurality of differently sized spinal support devices, that corresponds to said one or more measurements.

The first and second examples of adjustable accommodation may involve measuring the length of a predetermined span of the human's spine and then adjusting the NSU 10 and/or the UTSU 12 either closer to or away from the MBSU 11 based on this measured length. As an example, for a first person having a significantly longer measurement than a second person, the NSU 10 and/or the UTSU 12 are moved away from the MBSU 11 and releasably locked, thereby increasing the distance of gaps 14 and 16 for the first person and moved closer to the MBSU 11 and releasably locked for the second person thereby decreasing the distance of the gaps 14 and 16. For examples that involve measuring the length of a predetermined span of the human's spine, adjustments can be made for various conditions, non-exclusively including those suffering from abnormal spinal curvatures, abnormal disc sizes, and temporal conditions such as when they woke up from sleep, based on the degree of offset of said characteristic. For example, if a normal curvature span measurement of 27 inches corresponds to a particular configuration of the support units (10, 11, and 12), a person suffering from lordosis or kyphosis having a 30 inch measurement might utilize the same configuration of support units (10, 11, and 12) if there is a 3 inch offset.

According to some examples, when the UTSU 12 and the NSU 10 are moved away from the MBSU 11 and releasably locked, the second gap 16 between the UTSU 12 and the MBSU 11 is longer in length than the first gap 14 between the NSU 10 and the MBSU 11. According to some examples, the length of the second gap 16 is between 1.025 to 1.225 times greater than the length of the first gap 14, including 1.125 times greater than the length of the first gap 14.

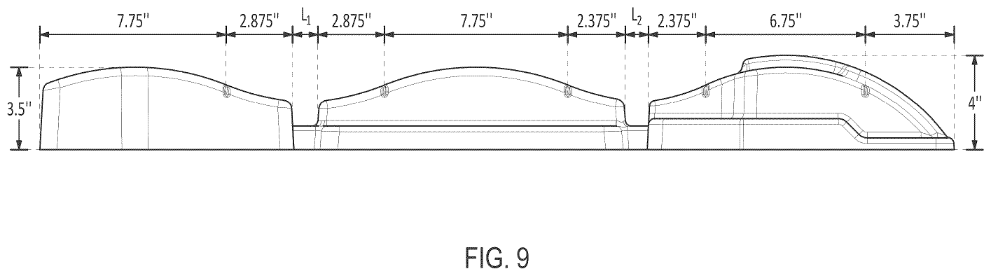

As shown in FIG. 9, the MBSU, UTSU, and NSU are each 3.5 inches high at the peak of the convex surface that supports the user. The lateral supports 26 of the NSU are higher (in the depicted example, the top of supports 26 is 4 inches high, the supports themselves being 0.5 inches in height.) The inflection points of the device are at a height of 2.75 inches and the ends of the MBSU, UTSU, and NSU are 2 inches high. These heights, together with the other dimensions and curvatures of the MBSU, UTSU, and NSU, facilitate comfortable and/or beneficial support of the user's back.

In some examples, the heights of the inflection points of the device can be calculated and/or otherwise selected based on the radius of curvature of the corresponding gravity area.

In some examples, a layer of flexible material (e.g., a yoga mat, a pad, and/or the like) is disposed over the top of device 20, or portions of the device, to help the device accommodate a person with a large spine height. A layer having a thickness of 0.5 inches and/or any other suitable thickness may be used.

The following is a non-limiting illustrative method of measuring a particular person and adjusting the spinal support device 20 based on said measurement. The predetermined span of the human's spine that is measured can be the distance between the top of the T1 vertebra to the bottom of the sacrum. This span can be measured in any suitable way, including when the user is standing up, however can easily be done by having the user sit upright on a surface, such as the floor, mat, chair, or stool, and then measuring the distance between the top of the T1 vertebra and the surface (e.g., the floor, the mat, the seat of the chair, or seat of the stool).

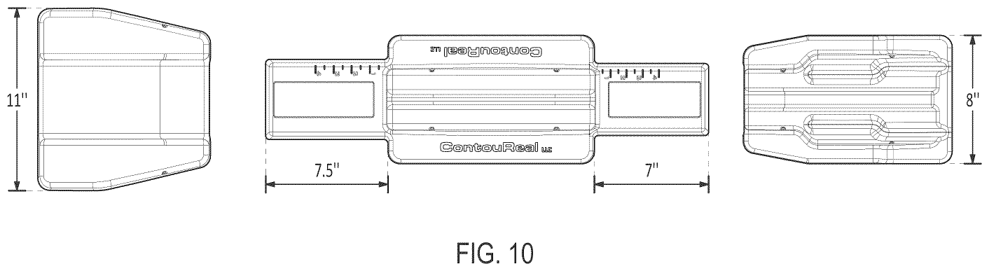

Table 1 below illustrates this example. The quantities listed in Table 1 are applicable to, e.g., the example spinal support device depicted in FIGS. 9-10. FIGS. 9-10 depict illustrative dimensions for various portions of this example device. In FIG. 9, the length of gap 16 is designated L1 and the length of gap 14 is designated L2.

Table 1 lists a column of distances in inches based on the height from the top of the T1 vertebra to the bottom of the sacrum (“Height from T1 to bottom of sacrum”). As this length goes up from 23 to 33 inches by 0.5 inch increments, the gaps 14/16 can increase by the amount shown in the corresponding columns labeled “Gap 14 (L2)” and “Gap 16 (L1)”, respectively. For example, when the height from the top of the T1 vertebra to the bottom of the sacrum is 23″ or less, the NSU 10 and the UTSU 12 are adjacent to the MBSU 11 such that no first or second gap 14/16 exists (i.e., L1 and L2 are both equal to zero). When the height from the top of the T1 vertebra to the bottom of the sacrum is between 23 to 25 inches, the first gap 14 (i.e., L2) is between 0 to 1 inches and the second gap 16 (i.e., L1) is between 1.025 to 1.225 times greater than the length of the first gap 14, including 0″ if the first gap 14 does not exist at 0 inches. When the height from the top of the T1 vertebra to the bottom of the sacrum is between 25 to 27 inches, the first gap 14 is between 1 to 2 inches and the second gap 16 is between 1.025 to 1.225 times greater than the length of the first gap 14. Similarly, when the height from the top of the T1 vertebra to the bottom of the sacrum is between 27 to 29 inches, the first gap 14 is between 2 to 3 inches and the second gap 16 is between 1.025 to 1.225 times greater than the length of the first gap 14. When the height from the top of the T1 vertebra to the bottom of the sacrum is between 29 to 31 inches, the first gap 14 is between 3 to 4 inches and the second gap 16 is between 1.025 to 1.225 times greater than the length of the first gap 14. When the height from the top of the T1 vertebra to the bottom of the sacrum is between 31″ to 33″, the first gap 14 is between 4 to 5 inches and the second gap 16 is between 1.025 to 1.225 times greater than the length of the first gap 14.

Accordingly, in some examples, defining the distance between the apex of the neck support unit and the apex of the mid-back support unit to be a first baseline value when the height is 23 inches, and the distance between the apex of the mid-back support unit and the apex of the upper thigh support unit to be a second baseline value when the height is 23 inches, a first distance between the apex of the neck support unit and the apex of the mid-back support unit exceeds the first baseline value by 0.25 inches for every half inch by which the height exceeds 23 inches, and a second distance between the apex of the upper thigh support unit and the apex of the mid-back support unit exceeds the second baseline value by an amount between 1.025 and 1.225 times a difference between the first distance and the first baseline value.

In at least some cases, this arrangement can also be described by saying that the first distance is equal to the first baseline value plus a first difference value, wherein the first difference value is half of the quantity (height in inches-23 inches), and the second distance is equal to 1.025 to 1.225 times the first difference value. In some examples, baseline heights other than 23 inches are used.

In the example depicted in FIGS. 9-10, the first and second baseline values correspond to a configuration in which gaps 14 and 16 do not exist (i.e., L2 and L1 are equal to zero). That is, in this example, the apex of the neck support unit and the apex of the mid-back support unit are separated by the first baseline value when no gap exists between the neck support unit and the mid-back support unit, and the apex of the mid-back support unit and the upper thigh support unit are separated by the second baseline value when no gap exists between the mid-back support unit and the upper thigh support unit. In other examples, however, the first and second baseline values may correspond to configurations in which L2 and/or L1 are nonzero (for instance, in an example in which the MBSU, NSU, and/or UTSU are shorter in the longitudinal direction than they are in the example of FIGS. 9-10, nonzero gaps could exist when the apexes of the units are separated by the first and second baseline values).

For the example spinal support device depicted in FIGS. 9-10, when first gap 14 (i.e., L2) is 0 inches, the upper inflection point on the MBSU and the lower inflection point on the NSU are separated by 4.75 inches; when second gap 16 (i.e., L1) is 0 inches, the lower inflection point on the MBSU and the upper inflection point on the UTSU are separated by 5.75 inches. The distances between these pairs of inflection points change accordingly as the first and second gaps are adjusted based on measured height from the top of the T1 vertebra to the bottom of the sacrum, as described by Table 1.

Referring again to the model described above in which the transition points on the user's spine are likely to be found naturally at distances A, 2A, 2A+B, and 2A+2B from the C1 vertebra, the spinal span between the top of the T1 vertebra to the bottom of the sacrum corresponds to the distance 2A+2B. Adjusting the size of gaps 14 and 16 brings the inflection points of device 20 into approximate alignment with the transition points of the user's spine (e.g., the transition points and inflection points are aligned within an acceptable tolerance, such as 0.5 inches). As an illustration, in the example device depicted in FIGS. 9-10, A corresponds to (½)(6.75″+2.375″+L2+2.375″), and B corresponds to (½)(7.75″+2.875″+L1+2.875″). The values provided in Table 1 provide sizes of L1 and L2 that bring the inflection points on the device into approximate alignment with the transition points of the spine.

The values provided in Table 1 are merely example values and similar measurements can be used to achieve similar configurations or ratios between values. Devices 20 accommodating people having smaller or larger spans from the top of the T1 vertebra to the bottom of the sacrum are also readily included herein. For example, although the values of Table 1 reflect spans that are common for adults, devices for children or shorter adults having this span under 23″, such as between 16″-23″, and for tall people having this span over 33″, such as 33-38″, are also envisioned herein. Devices configured for users with this span under 23″ and/or over 33″ can have adjustable gaps with distances and/or ratios similar to those shown in Table 1.

In addition to measuring the span from top of the T1 vertebra to the bottom of the sacrum, other spans are readily envisioned herein including the bottom of the C7 vertebra, the bottom of the T1 vertebra, or the top/bottom of the T2 vertebra to the bottom or top of the sacrum, for example. The difference between the top of the T1 vertebra and another upper marker position (e.g., bottom of the C7 vertebra, the bottom of the T1 vertebra or top/bottom of T2 vertebra) can readily be determined and the values in Table 1 can be adjusted accordingly. Likewise, the difference between the bottom of the sacrum and another lower marker position (e.g., top of sacrum) can readily be determined and the values in Table 1 can be adjusted accordingly. For example, if the upper marker position is 0.25 inches above the top of the T1 vertebra (e.g., the bottom of the C7 vertebra) and the lower marker position is 0.25 inches below the bottom of the sacrum, the values of the height column in Table 1 could be increased by 0.5 inch for each row, while the remaining values in the other columns would remain the same. Similarly, if the upper marker position is 0.25 inches above the top of the T1 vertebra (e.g., the bottom of the C7 vertebra) and the lower marker position is 0.25 inches above the bottom of the sacrum, the height column in Table 1 would remain the same, as would the remaining values in the other columns.

In some examples, when using intermittent locking points 5, each point corresponds to a predetermined setting (e.g., first column of Table 1), which in turn corresponds to distances in the gaps 14/16 (and ratios between the gaps) and the measurement of a designated span on the user. According to some examples, the device 20 non-exclusively includes 21 locking points, or 1-10, or 1-15, or 1-20, or 1-25 locking points. While Table 1 increases in 0.5 inch increments, devices increasing in other increments, e.g., 1 inch, 1.5 inch, or 0.25 inch increments are also envisioned herein. The Table 1 values can readily be calculated and adjusted according to these different increments. For example, to use 1 inch increments in the “Height” column instead of 0.5 inches as currently shown, one would use only every other row of values (i.e., alternating rows), and the “Settings” column thus increases by 0.5 inch increments.

For the third example of accommodating individualized users by providing a plurality of different sized non-adjustable devices 20, where the support units (10, 11, 12) are not slidable along the longitudinal axis on the base 7, Table 1 and/or a similar table can be used to select one of a plurality of spinal support devices 20. For example, two or more fixed devices 20 can be created for two or more of the 21 rows of Table 1 (or other suitable dimensions and gaps) and the user's device can be selected from these two or more devices based on the measurement of the designated spinal span, such as the top of the T1 vertebra to the bottom of the sacrum. All variations described above for adjustable devices can be utilized with the plurality of fixed devices, including different spinal spans for measurements, spinal spans from the top of the T1 vertebra to the bottom of the sacrum that are shorter than 23″ or longer than 33″, and the ratios between the first and second gaps 14/16.

According to some examples (not shown), motorized massage balls can be made to travel on a contoured fixed or guided track that follows the convex body curves. Optionally, massage balls can be positioned within tracks on the convex shape topsides 1a/1b and/or 2a/2b where they can roll on the tracks like ball bearings to increase blood flow. Further examples, not shown, can include a vibrating motor incorporated into the device 20 to improve blood circulation and/or loosen muscles, which may or may not be coupled with one or more of the support units (10, 11, 12) and/or the base 7. Further examples include coupling exercise equipment to the device 20. Non-exclusive options include ropes, rubber or elastic bands, bars, cages, and devices that can press the person against the device 20, and/or allow them to lift weights, and/or perform strengthening or stretching movements.

Some example methods involve a user taking a measurement of a predetermined span of the human's spine that corresponded to predetermined configurations in a spinal support device 20. The spinal device 20 is adjusted or otherwise selected accordingly and optionally further adjusted based on additional measurements and/or user characteristics such as abnormal curvatures, abnormal discs, current time of day, etc. The user can lie on their customized device 20 for any suitable period of time, such as between 5 and 60 minutes while the apexes 6 of the support units (10, 11, 12) align with the centers of the three concave sections of the user's backside. The user can remain still lying on the device, or move such as to perform strengthening or stretching exercises. According to some example methods of use, a separate support, detached from the devices 20 provided herein, can be used to support the concave section of the backside of a user's ankles. This could be, e.g., a cylindrical device, such as a roller, wherein the convex form of the roller aligns with the concave section of the user.

The following paragraphs describe illustrative aspects and features of spinal support devices and associated methods, presented without limitation as a series of paragraphs, some or all of which may be alphanumerically designated for clarity and efficiency. Each of these paragraphs can be combined with one or more other paragraphs and/or with disclosure from elsewhere in this application in any suitable manner.

A1. A method of using a spinal support device on a human, comprising:
positioning a person on a spinal support device in a supine position, wherein the spinal support device comprises a base unit having a longitudinal axis along first and second ends, and having a neck support unit defining the first end, an upper thigh support unit defining the second end, and a mid-back support unit positioned between said neck and upper thigh support units, wherein the neck, upper thigh, and mid-back support units each have a convex shaped topside with an apex, wherein the neck support unit is configured to be slidable and releasably lockable along the longitudinal axis of the base unit both towards and away from the mid-back support unit so as to form a first gap between the neck support unit and the mid-back support unit, and wherein the upper thigh support unit is configured to be slidable and releasably lockable along the longitudinal axis of the base unit both towards and away from the mid-back support unit so as to form a second gap between the upper thigh support unit and the mid-back support unit;
wherein positioning the person on the spinal support device in the supine position includes positioning the person such that the apex of the mid-back support unit supports the center, or within 0.5 inches up or down from said center, of the L1 vertebra, the apex of the neck support unit supports the center, or within 0.5 inches up or down from said center, of the C5 vertebra, and the apex of the upper thigh support unit supports the upper thighs; and
measuring a predetermined span of the human's spine that is the distance between the top of the T1 vertebra to the bottom of the sacrum and adjusting the neck and upper thigh support units either closer to or away from the mid-back support unit based on the measured span, wherein when the measured span of the human spine is 23 inches or less, adjusting the neck and upper thigh support units includes positioning the neck and upper thigh support units adjacent to the mid-back support unit such that no first or second gaps exists.

A2. The method of paragraph A1, wherein when the measured span of the human spine is between 23 inches to 25 inches, the first gap is between 0 to 1 inches and the second gap is between 1.025 to 1.225 times greater than the length of the first gap.

A3. The method of paragraph A2, wherein when the measured span of the human spine is between 25 inches to 27 inches, the first gap is between 1 to 2 inches and the second gap is between 1.025 to 1.225 times greater than the length of the first gap.

A4. The method of paragraph A3, wherein when the measured span of the human spine is between 27 inches to 29 inches, the first gap is between 2 to 3 inches and the second gap is between 1.025 to 1.225 times greater than the length of the first gap.

A5. The method of paragraph A4, wherein when the measured span of the human spine is between 29 inches to 31 inches, the first gap is between 3 to 4 inches and the second gap is between 1.025 to 1.225 times greater than the length of the first gap.

A6. The method of paragraph A5, wherein when the measured span of the human spine is between 31 inches to 33 inches, the first gap is between 4 to 5 inches and the second gap is between 1.025 to 1.225 times greater than the length of the first gap.

B1. A method of using a spinal support device on a human, comprising:
positioning a person on a spinal support device in a supine position, wherein the spinal support device comprises a base unit having a longitudinal axis along first and second ends, and having a neck support unit defining the first end, an upper thigh support unit defining the second end, and a mid-back support unit positioned between said neck and upper thigh support units, wherein the neck, upper thigh, and mid-back support units each have a convex shaped topside with an apex, wherein the neck support unit is configured to be slidable and releasably lockable along the longitudinal axis of the base unit both towards and away from the mid-back support unit so as to form a first gap between the neck support unit and the mid-back support unit; and wherein the upper thigh support unit is configured to be slidable and releasably lockable along the longitudinal axis of the base unit both towards and away from the mid-back support unit so as to form a second gap between the upper thigh support unit and the mid-back support unit;
wherein positioning the person on the spinal support device in the supine position includes positioning the person such that the apex of the mid-back support unit supports the center, or within 0.5 inches up or down from said center, of the L1 vertebra, the apex of the neck support unit supports the center, or within 0.5 inches up or down from said center, of the C5 vertebra, and the apex of the upper thigh support unit supports the upper thighs; and
measuring a predetermined span of the human's spine that is the distance between the top of the T1 vertebra to the bottom of the sacrum and adjusting the neck and upper thigh support units either closer to or away from the mid-back support unit based on the measured span, wherein, when the measured span of the human spine is between 23 inches to 25 inches, adjusting the neck and upper thigh support units includes positioning the neck and upper thigh support units such that the first gap is between 0 to 1 inches and the second gap is between 1.025 to 1.225 times greater than the length of the first gap.

B2. The method of paragraph B1, wherein when the measured span of the human spine is between 25 inches to 27 inches, the first gap is between 1 to 2 inches and the second gap is between 1.025 to 1.225 times greater than the length of the first gap.

B3. The method of paragraph B2, wherein when the measured span of the human spine is between 27 inches to 29 inches, the first gap is between 2 to 3 inches and the second gap is between 1.025 to 1.225 times greater than the length of the first gap.

B4. The method of paragraph B3, wherein when the measured span of the human spine is between 29 inches to 31 inches, the first gap is between 3 to 4 inches and the second gap is between 1.025 to 1.225 times greater than the length of the first gap.

B5. The method of paragraph B4, wherein when the measured span of the human spine is between 31 inches to 33 inches, the first gap is between 4 to 5 inches and the second gap is between 1.025 to 1.225 times greater than the length of the first gap.

C1. A method of using a spinal support device on a human, comprising:
positioning a person on a spinal support device in a supine position, wherein the spinal support device comprises a base unit having a longitudinal axis along first and second ends, and having a neck support unit defining the first end, an upper thigh support unit defining the second end, and a mid-back support unit positioned between said neck and upper thigh support units, wherein the neck, upper thigh, and mid-back support units each have a convex shaped topside with an apex, wherein the neck support unit is configured to be slidable and releasably lockable along the longitudinal axis of the base unit both towards and away from the mid-back support unit so as to form a first gap between the neck support unit and the mid-back support unit; and wherein the upper thigh support unit is configured to be slidable and releasably lockable along the longitudinal axis of the base unit both towards and away from the mid-back support unit so as to form a second gap between the upper thigh support unit and the mid-back support unit;
wherein positioning the person on the spinal support device in the supine position includes positioning the person such that the apex of the mid-back support unit supports the center, or within 0.5 inches up or down from said center, of the L1 vertebra, the apex of the neck support unit supports the center, or within 0.5 inches up or down from said center, of the C5 vertebra, and the apex of the upper thigh support unit supports the upper thighs; and
measuring a predetermined span of the human's spine that is the distance between the top of the T1 vertebra to the bottom of the sacrum and adjusting the neck and upper thigh support units either closer to or away from the mid-back support unit based on the measured span, wherein, when the measured span of the human spine is between 25 inches to 27 inches, adjusting the neck and upper thigh support units includes positioning the neck and upper thigh support units such that the first gap is between 1 to 2 inches and the second gap is between 1.025 to 1.225 times greater than the length of the first gap.

C2. The method of paragraph C1, wherein when the measured span of the human spine is between 27 inches to 29 inches, the first gap is between 2 to 3 inches and the second gap is between 1.025 to 1.225 times greater than the length of the first gap.

C3. The method of paragraph C2, wherein when the measured span of the human spine is between 29 inches to 31 inches, the first gap is between 3 to 4 inches and the second gap is between 1.025 to 1.225 times greater than the length of the first gap.

C4. The method of paragraph C3, wherein when the measured span of the human spine is between 31 inches to 33 inches, the first gap is between 4 to 5 inches and the second gap is between 1.025 to 1.225 times greater than the length of the first gap.

D1. A method of supporting a human's spine, comprising:
measuring a span of a human's spine extending between a top of the T1 vertebra and a bottom of the sacrum;
preparing a spinal support device for supporting the measured human, wherein the spinal support device comprises:
   a first end, a second end, and a longitudinal axis extending between the first and second ends,
   a neck support unit at the first end,
   an upper thigh support unit at the second end, and
   a mid-back support unit disposed between the neck and upper thigh support units,
   wherein the neck, upper thigh, and mid-back support units each have a respective convex topside having a respective apex,
   wherein the neck support unit is configured to be slidable along the longitudinal axis relative to the mid-back support unit,
   wherein the upper thigh support unit is configured to be slidable along the longitudinal axis relative to the mid-back support unit,
   wherein when the spinal support device is in a baseline configuration, the neck support unit is disposed along the longitudinal axis such that the apex of the neck support unit is a first baseline distance from the apex of the mid-back support unit, and the upper thigh support unit is disposed along the longitudinal axis such that the apex of the upper thigh support unit is a second baseline distance from the apex of the mid-back support unit, and
   wherein the baseline configuration is defined such that when the spinal support device is in the baseline configuration, the spinal support device is configured to support a baseline human having a measured span of 23 inches such that the apex of the mid-back support unit supports the center of the baseline human's L1 vertebra, the apex of the neck support unit supports the center of the baseline human's C5 vertebra, and the apex of the upper thigh support unit supports the baseline human's upper thighs; and
wherein preparing the spinal support device for supporting the measured human includes:
   positioning the neck support unit such that a first distance between the apex of the neck support unit and the apex of the mid-back support unit exceeds the first baseline distance by 0.25 inches for every half inch by which the measured span of the measured human's spine exceeds 23 inches, and
   positioning the upper thigh support unit such that a second distance between the apex of the upper thigh support unit and the apex of the mid-back support unit exceeds the second baseline distance by an amount between 1.025 and 1.225 times a difference between the first distance and the first baseline distance.

D2. The method of paragraph D1, further comprising positioning the measured human on the spinal support device.

D3. The method of paragraph D2, wherein positioning the measured human on the spinal support device is performed after preparing the spinal support device for supporting the measured human.

D4. The method of paragraph D1, wherein one or both of the neck support unit and the upper thigh support unit is configured to be releasably lockable along the longitudinal axis.

D5. The method of paragraph D4, wherein the one or both of the neck support unit and the upper thigh support unit is configured to be releasably lockable only at one or more predetermined positions along the longitudinal axis.

D6. The method of paragraph D1, wherein the spinal support device is dimensioned such that the neck support unit and the upper thigh support unit each abut the mid-back support unit when the spinal support device is in the baseline configuration.

D7. The method of paragraph D1, wherein the mid-back support unit has a pair of projections extending from opposing ends of the mid-back support unit parallel to the longitudinal axis, and the neck support unit and the upper thigh support unit are each configured to be slidable along a respective one of the projections.

D8. The method of paragraph D1, wherein the convex topside of the mid-back support unit comprises a pair of inflection points equidistant along the longitudinal axis from the apex of the mid-back support unit, and the neck support unit and the upper thigh support unit each comprise at least one inflection point respectively.

E1. A method of supporting a human subject's spine, comprising:
preparing a spinal support device for supporting a human subject, wherein the spinal support device comprises:
   a first end, a second end, and a longitudinal axis extending between the first and second ends,
   a neck support unit at the first end,
   an upper thigh support unit at the second end, and
   a mid-back support unit disposed between the neck and upper thigh support units,
   wherein the neck, upper thigh, and mid-back support units each have a respective convex topside with a respective apex,
   wherein the neck support unit is configured to be slidable along the longitudinal axis relative to the mid-back support unit,
   wherein the upper thigh support unit is configured to be slidable along the longitudinal axis relative to the mid-back support unit, and
   wherein, when the neck support unit is disposed at a first baseline distance from the mid-back support unit and the upper thigh support unit is disposed at a second baseline distance from the mid-back support unit, the spinal support device is configured to support a hypothetical human having a baseline spinal span between predetermined spine portions; and
wherein preparing the spinal support device for supporting the human subject includes:
   positioning the neck support unit such that a first distance between the neck support unit and the mid-back support unit is equal to the first baseline distance plus a first difference value, wherein the first difference value is half of a value equal to: (a spinal span of the human subject between the predetermined portions of the human subject's spine minus the baseline spinal span of the hypothetical human); and
   positioning the upper thigh support unit such that a second distance between the upper thigh support unit and the mid-back support unit is equal to 1.025 to 1.225 times the first difference value.

E2. The method of paragraph E1, wherein the predetermined spine portions are the top of the T1 vertebra and the bottom of the sacrum, such that the baseline spinal span is a distance between the top of the T1 vertebra and the bottom of the sacrum of the hypothetical human, and the spinal span of the human subject is a distance between the top of the T1 vertebra and the bottom of the sacrum of the human subject.

E3. The method of paragraph E2, wherein the baseline spinal span is 23 inches.

E4. The method of paragraph E1, further comprising positioning the human subject against the spinal support device.

E5. The method of paragraph E4, wherein positioning the human subject against the spinal support device comprises positioning the human subject on the spinal support device in a supine position such that the apex of the mid-back support unit supports the center of the L1 vertebra of the human subject, the apex of the neck support unit supports the center of the C5 vertebra of the human subject, and the apex of the upper thigh support unit supports the upper thighs of the human subject.

E6. The method of paragraph E5, further comprising measuring the spinal span of the human subject prior to positioning the human subject on the spinal support device in the supine position.

E7. The method of paragraph E5, wherein the convex topside of the upper thigh support unit has an inflection point in curvature, and wherein positioning the human subject on the spinal support device in the supine position includes positioning the human subject such that the inflection point is aligned with the human subject's sacrococcygeal ligament.

E8. The method of paragraph E1, wherein the mid-back support unit has a pair of projections extending from opposing ends of the mid-back support unit parallel to the longitudinal axis, and the neck support unit and the upper thigh support unit are each slidably mounted to a respective one of the projections.

E9. The method of paragraph E1, wherein the first distance and the first baseline distance are each defined between the apex of the neck support unit and the apex of the mid-back support unit, and the second distance and the second baseline distance are each defined between the apex of the upper thigh support unit and the apex of the mid-back support unit.

F1. A method of supporting a first human's spine, comprising:
preparing a spinal support device for supporting a first human based on a spinal length of the first human between the top of the first human's T1 vertebra and the bottom of the first human's sacrum, wherein the spinal support device comprises:
   a mid-back support comprising a curved surface, a first end, and a second end, wherein a peak of the curved surface is disposed between the first and second ends, and
   a neck support comprising a curved surface having a peak, wherein the neck support is slidably attached to the mid-back support, such that a distance between the peak of the neck support and the peak of the mid-back support is adjustable by sliding the neck support toward or away from the mid-back support,
   wherein when the spinal support device is in a baseline configuration, the neck support is disposed such that the peak of the neck support is a first baseline distance from the peak of the mid-back support, the baseline configuration being defined such that when the spinal support device is in the baseline configuration, the spinal support device is configured to support a hypothetical human having a spinal length of 23 inches such that the peak of the mid-back support engages the center of the hypothetical human's L1 vertebra and the peak of the neck support engages the center of the hypothetical human's C5 vertebra; and
wherein preparing the spinal support device for supporting the first human includes positioning the neck support such that a first distance between the peak of the neck support and the peak of the mid-back support exceeds the first baseline distance by 0.25 inches for every half inch by which the spinal length of the first human 5 exceeds 23 inches.

F2. The method of paragraph F1, wherein the spinal support device further comprises an upper thigh support adjustably attached to the mid-back support, and wherein preparing the spinal support device for supporting the first human further includes positioning the upper thigh support.

F3. The method of paragraph F1, wherein the curved surface of the mid-back support has a pair of inflection points each disposed on a respective side of the peak of the mid-back support.

TABLE 1

| | Gap 14 (L2) | Gap 16 (L1) | Height from T1 to Bottom |
|---|---|---|---|
| Setting | (inches) | (inches) | of Sacrum (inches) |
| 0 | 0 | 0 | 23 |
| .25 | .25 | .28 | 23.5 |
| .5 | .5 | .625 | 24 |
| .75 | .75 | .84 | 24.5 |
| 1 | 1 | 1.125 | 25 |
| 1.25 | 1.25 | 1.4 | 25.5 |
| 1.5 | 1.5 | 1.875 | 26 |
| 1.75 | 1.75 | 1.97 | 26.5 |
| 2 | 2 | 2.25 | 27 |
| 2.25 | 2.25 | 2.53 | 27.5 |
| 2.5 | 2.5 | 2.8 | 28 |
| 2.75 | 2.75 | 3.1 | 28.5 |
| 3 | 3 | 3.375 | 29 |
| 3.25 | 3.25 | 3.65 | 29.5 |
| 3.5 | 3.5 | 3.93 | 30 |
| 3.75 | 3.75 | 4.21 | 30.5 |
| 4 | 4 | 4.5 | 31 |
| 4.25 | 4.25 | 4.78 | 31.5 |
| 4.5 | 4.5 | 5.06 | 32 |
| 4.75 | 4.75 | 5.34 | 32.5 |
| 5 | 5 | 5.625 | 33 |

1. A method of supporting a human's spine, comprising:
measuring a span of a human's spine extending between a top of the T1 vertebra and a bottom of the sacrum;
preparing a spinal support device for supporting the measured human, wherein the spinal support device comprises:
a first end, a second end, and a longitudinal axis extending between the first and second ends,
a neck support unit at the first end,
an upper thigh support unit at the second end, and
a mid-back support unit disposed between the neck and upper thigh support units,
wherein the neck, upper thigh, and mid-back support units each have a respective convex topside having a respective apex,
wherein the neck support unit is configured to be slidable along the longitudinal axis relative to the mid-back support unit,
wherein the upper thigh support unit is configured to be slidable along the longitudinal axis relative to the mid-back support unit,
wherein when the spinal support device is in a baseline configuration, the neck support unit is disposed along the longitudinal axis such that the apex of the neck support unit is a first baseline distance from the apex of the mid-back support unit, and the upper thigh support unit is disposed along the longitudinal axis such that the apex of the upper thigh support unit is a second baseline distance from the apex of the mid-back support unit, and
wherein the baseline configuration is defined such that when the spinal support device is in the baseline configuration, the spinal support device is configured to support a baseline human having a measured span of 23 inches such that the apex of the mid-back support unit supports the center of the baseline human's L1 vertebra, the apex of the neck support unit supports the center of the baseline human's C5 vertebra, and the apex of the upper thigh support unit supports the baseline human's upper thighs; and
wherein preparing the spinal support device for supporting the measured human includes:
positioning the neck support unit such that a first distance between the apex of the neck support unit and the apex of the mid-back support unit exceeds the first baseline distance by 0.25 inches for every half inch by which the measured span of the measured human's spine exceeds 23 inches, and
positioning the upper thigh support unit such that a second distance between the apex of the upper thigh support unit and the apex of the mid-back support unit exceeds the second baseline distance by an amount between 1.025 and 1.225 times a difference between the first distance and the first baseline distance.

2. The method of claim 1, further comprising positioning the measured human on the spinal support device.

3. The method of claim 2, wherein positioning the measured human on the spinal support device is performed after preparing the spinal support device for supporting the measured human.

4. The method of claim 1, wherein one or both of the neck support unit and the upper thigh support unit is configured to be releasably lockable along the longitudinal axis.

5. The method of claim 4, wherein the one or both of the neck support unit and the upper thigh support unit is configured to be releasably lockable only at one or more predetermined positions along the longitudinal axis.

6. The method of claim 1, wherein the spinal support device is dimensioned such that the neck support unit and the upper thigh support unit each abut the mid-back support unit when the spinal support device is in the baseline configuration.

7. The method of claim 1, wherein the mid-back support unit has a pair of projections extending from opposing ends of the mid-back support unit parallel to the longitudinal axis, and the neck support unit and the upper thigh support unit are each configured to be slidable along a respective one of the projections.

8. The method of claim 1, wherein the convex topside of the mid-back support unit comprises a pair of inflection points equidistant along the longitudinal axis from the apex of the mid-back support unit, and the neck support unit and the upper thigh support unit each comprise at least one inflection point respectively.

9. A method of supporting a human subject's spine, comprising:
preparing a spinal support device for supporting a human subject, wherein the spinal support device comprises:
a first end, a second end, and a longitudinal axis extending between the first and second ends,
a neck support unit at the first end,
an upper thigh support unit at the second end, and
a mid-back support unit disposed between the neck and upper thigh support units,
wherein the neck, upper thigh, and mid-back support units each have a respective convex topside with a respective apex,
wherein the neck support unit is configured to be slidable along the longitudinal axis relative to the mid-back support unit,
wherein the upper thigh support unit is configured to be slidable along the longitudinal axis relative to the mid-back support unit, and
wherein, when the neck support unit is disposed at a first baseline distance from the mid-back support unit and the upper thigh support unit is disposed at a second baseline distance from the mid-back support unit, the spinal support device is configured to support a hypothetical human having a baseline spinal span between predetermined spine portions; and
wherein preparing the spinal support device for supporting the human subject includes:
positioning the neck support unit such that a first distance between the neck support unit and the mid-back support unit is equal to the first baseline distance plus a first difference value, wherein the first difference value is half of a value equal to: (a spinal span of the human subject between the predetermined portions of the human subject's spine minus the baseline spinal span of the hypothetical human); and
positioning the upper thigh support unit such that a second distance between the upper thigh support unit and the mid-back support unit is equal to 1.025 to 1.225 times the first difference value.

10. The method of claim 9, wherein the predetermined spine portions are the top of the T1 vertebra and the bottom of the sacrum, such that the baseline spinal span is a distance between the top of the T1 vertebra and the bottom of the sacrum of the hypothetical human, and the spinal span of the human subject is a distance between the top of the T1 vertebra and the bottom of the sacrum of the human subject.

11. The method of claim 10, wherein the baseline spinal span is 23 inches.

12. The method of claim 9, further comprising positioning the human subject against the spinal support device.

13. The method of claim 12, wherein positioning the human subject against the spinal support device comprises positioning the human subject on the spinal support device in a supine position such that the apex of the mid-back support unit supports the center of the L1 vertebra of the human subject, the apex of the neck support unit supports the center of the C5 vertebra of the human subject, and the apex of the upper thigh support unit supports the upper thighs of the human subject.

14. The method of claim 13, further comprising measuring the spinal span of the human subject prior to positioning the human subject on the spinal support device in the supine position.

15. The method of claim 13, wherein the convex topside of the upper thigh support unit has an inflection point in curvature, and wherein positioning the human subject on the spinal support device in the supine position includes positioning the human subject such that the inflection point is aligned with the human subject's sacrococcygeal ligament.

16. The method of claim 9, wherein the mid-back support unit has a pair of projections extending from opposing ends of the mid-back support unit parallel to the longitudinal axis, and the neck support unit and the upper thigh support unit are each slidably mounted to a respective one of the projections.

17. The method of claim 9, wherein the first distance and the first baseline distance are each defined between the apex of the neck support unit and the apex of the mid-back support unit, and the second distance and the second baseline distance are each defined between the apex of the upper thigh support unit and the apex of the mid-back support unit.

18. A method of supporting a first human's spine, comprising:
preparing a spinal support device for supporting a first human based on a spinal length of the first human between the top of the first human's T1 vertebra and the bottom of the first human's sacrum, wherein the spinal support device comprises:
a mid-back support comprising a curved surface, a first end, and a second end, wherein a peak of the curved surface is disposed between the first and second ends, and
a neck support comprising a curved surface having a peak, wherein the neck support is slidably attached to the mid-back support, such that a distance between the peak of the neck support and the peak of the mid-back support is adjustable by sliding the neck support toward or away from the mid-back support,
wherein when the spinal support device is in a baseline configuration, the neck support is disposed such that the peak of the neck support is a first baseline distance from the peak of the mid-back support, the baseline configuration being defined such that when the spinal support device is in the baseline configuration, the spinal support device is configured to support a hypothetical human having a spinal length of 23 inches such that the peak of the mid-back support engages the center of the hypothetical human's L1 vertebra and the peak of the neck support engages the center of the hypothetical human's C5 vertebra; and
wherein preparing the spinal support device for supporting the first human includes positioning the neck support such that a first distance between the peak of the neck support and the peak of the mid-back support exceeds the first baseline distance by 0.25 inches for every half inch by which the spinal length of the first human exceeds 23 inches.

19. The method of claim 18, wherein the spinal support device further comprises an upper thigh support adjustably attached to the mid-back support, and wherein preparing the spinal support device for supporting the first human further includes positioning the upper thigh support.

20. The method of claim 18, wherein the curved surface of the mid-back support has a pair of inflection points each disposed on a respective side of the peak of the mid-back support.
